(19) United States
(12) Patent Application Publication
(10) Pub. No.: US 2008/0123778 A1
(43) Pub. Date: May 29, 2008

(54) Data receiving apparatus

(76) Inventors: Yoshihisa Ikeda, Kawasaki (JP); Chikashi Hashimoto, Kawasaki (JP)

Correspondence Address: BINGHAM MCCUTCHEN LLP, 2020 K Street, N.W., Intellectual Property Department, WASHINGTON, DC, 20006, US

(21) Appl. No.: 11/987,465

(22) Filed: Nov. 30, 2007

Related U.S. Application Data
(63) Continuation of application No. PCT/JP2005/009964, filed on May 31, 2005.

(51) Int. Cl. H04L 25/10

(52) U.S. Cl. 375/317

(57) ABSTRACT

A data receiving apparatus capable of reducing bit errors caused by noise includes a threshold value calculation unit, a judgment timing output unit, a data judgment unit, and a majority-rule judgment unit. The threshold value calculation unit calculates a plurality of different threshold values to judge whether the status of a received signal is ‘1’ or ‘0’. The judgment timing output unit outputs a plurality of judgment timings in a one-bit section of the received signal. The data judgment unit compares the received signal with each of the threshold values at the judgment timings and judges whether the status of the received signal is ‘1’ or ‘0’. The majority-rule judgment unit decides, by majority rule, on the ‘1’ and ‘0’ statuses obtained by the data judgment unit in the one-bit section and outputs the majority of the ‘1’ and ‘0’ statuses as the signal status of the received signal.

This application is a continuing application, filed under 35 U.S.C. §111(a), of International Application PCT/JP2005/009964, filed May 31, 2005.

### BACKGROUND OF THE INVENTION

1. Field of the Invention

The present invention relates to data receiving apparatuses, and particularly to a data receiving apparatus for judging a received signal that can take two or more values.

2. Description of the Related Art

In data communication, the bit error rate is one important parameter for improving the quality of communication. The bit error rate is adversely affected by noise in a communication apparatus, a transmission path, or the like.

Noise includes switching noise in the communication apparatus, distortion caused by a power supply system, a high-frequency component supplied to a transmission line: there are a variety of factors, and the magnitude of noise and the period of fluctuation vary. Although measures against a variety of noise are taken in communication apparatuses, noise cannot be eliminated completely. Some communication apparatuses have improved the bit error rate by performing processing to correct a wrong bit or the like in accordance with forward error correction (FEC) and other coding theories.

Communication apparatuses that process digital data generally incorporate a data receiving apparatus for judging whether a received signal (received data) is in a ‘1’ or ‘0’ status in accordance with a threshold value. The data receiving apparatus judges whether the received data is in the ‘1’ or ‘0’ status: If the level of amplitude of the received data is greater than or equal to the threshold value, the status is judged to be ‘1’; if the level of amplitude is smaller than the threshold value, the status is judged to be ‘0’.

FIG. 15 is a view illustrating a judgment operation of a conventional data receiving apparatus that judges whether a signal is in the ‘1’ or ‘0’ status in accordance with a threshold value. A signal waveform W101 shown in the figure represents the waveform of received data input to the data receiving apparatus. The data receiving apparatus compares the signal waveform W101 with the threshold value at judgment timings marked with arrows in the figure. If the voltage level of the signal waveform W101 is higher than or equal to the threshold value, the status is judged to be ‘1’. If the voltage level is lower than the threshold value, the status is judged to be ‘0’. The threshold value is specified generally at the center of the amplitude of the input received data. If noise is too small to exceed the threshold value, a misjudgment will not occur. Shown in the row of “signal judgment” in the figure are the signal statuses of the signal waveform W101 judged by the data receiving apparatus.

FIG. 16 is a view illustrating a judgment operation of a conventional data receiving apparatus that uses a threshold band. The figure shows a signal waveform W102 representing the waveform of received data input to the data receiving apparatus and noise N101 and N102 representing noise added to the signal waveform W102.

As shown in the figure, the data receiving apparatus has two threshold values: ‘1’ judgment threshold value and ‘0’ judgment threshold value. Once the data receiving apparatus recognizes the status of ‘0’, the signal waveform W102 is recognized as being ‘1’ only when the signal waveform W102 exceeds both the ‘0’ judgment threshold value and the ‘1’ judgment threshold value. Once the status of ‘1’ is recognized, the signal waveform W102 is recognized as being ‘0’ only when the signal waveform W102 falls below both the ‘1’ judgment threshold value and the ‘0’ judgment threshold value. Therefore, if the noise N101 as shown in the figure is added to the signal waveform W102 in the ‘0’ status, the data receiving apparatus does not judge the status to be ‘1’. If the noise N102 as shown in the figure is added to the signal waveform W102 in the ‘1’ status, the data receiving apparatus does not judge the status to be ‘0’, either. The “threshold-value comparison result” shown in the figure indicates the signal statuses of the signal waveform W102 recognized by the data receiving apparatus through the comparison between the signal waveform W102 and the ‘1’ judgment threshold value and the ‘0’ judgment threshold value. The data receiving apparatus obtains the recognized signal statuses at timings marked with arrows in the figure and outputs them as shown in the row of “signal judgment” in the figure. The 1/0 judgment exhibiting hysteresis in accordance with the threshold band provides a higher degree of noise immunity than the judgment operation shown in FIG. 15.

In one broadcast confirmation signal detection system (refer to Japanese Unexamined Patent Publication No. 55-165081, for instance), a distinction signal is provided for each of a plurality of different threshold values for independent detection and judgment, making it possible to detect identification information without detection error in a variety of broad reception ranges. One majority-rule judgment circuit (refer to Japanese Unexamined Patent Publication No. 6-6329) has a simplified structure of a majority-rule judgment circuit for securing the quality of received information in digital wireless communication.

Even if a threshold band is used to prevent noise from causing a misjudgment as shown in FIG. 16, a noise level exceeding the threshold band would result in a misjudgment.

FIG. 17 is a view illustrating an example of misjudgment resulting from noise exceeding the threshold band. In the figure, a signal waveform W103 represents the waveform of received data input to the data receiving apparatus, and noise N103 and N104 represents noise added to the signal waveform W103. The ‘1’ judgment threshold value, the ‘0’ judgment threshold value, the threshold-value comparison result, the judgment timing, and the signal judgment shown in the figure have the same meanings as those shown in FIG. 16, and descriptions of those items will be omitted.

When the noise N103, which exceeds the ‘1’ judgment threshold value, is added to the signal waveform W103 in the ‘0’ status, as shown in the figure, the data receiving apparatus misjudges the status to be ‘1’ although the signal waveform W103 is actually in the ‘0’ status. When the noise N104, which falls below the ‘0’ judgment threshold value, is added to the signal waveform W103 in the ‘1’ status, the status is misjudged to be ‘0’ although the signal waveform W103 is actually in the ‘1’ status.

If the level of the signal input to the data receiving apparatus is varying, a narrowed difference between any threshold value and the signal level would increase the possibility of misjudgment owing to noise, depending on the signal level.

FIG. 18 is a view illustrating an example of signal misjudgment depending on the signal level. The figure shows a signal waveform W104 of the received data input to the data receiving apparatus and a signal waveform W105 having a smaller signal level than the signal waveform W104. That type of difference in signal level results from the distance from the communication apparatus for sending the signal, for instance. As the distance from the communication apparatus for sending the signal increases, the signal level decreases. The figure also shows noise N105 and N106 having the same noise level, added to the signal waveforms W104 and W105, respectively. Noise having the same noise level, such as the noise N105 and N106, can occur in a communication apparatus for receiving the signal. The threshold value, the judgment timing, and the signal judgment shown in the figure have the same meanings as those in FIG. 15, and descriptions thereof will be omitted.

The noise N105, added to the shown signal waveform W104, does not cross the threshold value, so that the signal waveform W104 in the ‘1’ status is not misjudged to be ‘0’. When the noise N106, having the same noise level as the noise N105, is added to the signal waveform W105 having a smaller signal level, the threshold value is crossed, and the signal waveform W106 in the ‘1’ status would be misjudged to be in the ‘0’ status. As the signal level decreases, the threshold value becomes relatively high with respect to the signal, raising the possibility of misjudgment.

Moreover, using just one judgment timing may cause misjudgment if very short noise is added at the judgment timing.

FIG. 19 is a view illustrating an example where noise is added at judgment timing. In the figure, a signal waveform W106 represents the waveform of received data input to the data receiving apparatus, and noise N107 represents noise added to the signal waveform W106. The threshold value, the judgment timing, and the signal judgment have the same meanings as those shown in FIG. 15, and descriptions thereof will be omitted.

As shown in the figure, when the noise N107 is added to the signal waveform W106 at judgment timing, the signal waveform W106 in the ‘0’ status is misjudged to be in the ‘1’ status.

### SUMMARY OF THE INVENTION

In view of the foregoing, it is an object of the present invention to provide a data receiving apparatus for judging received data values of a received signal in accordance with a plurality of threshold values at a plurality of judgment timings, and for making a final judgment by majority rule according to judgment results to reduce bit errors resulting from noise.

To accomplish the above object, there is provided a data receiving apparatus. This data receiving apparatus includes the following elements: a threshold value calculation unit for calculating n different threshold values (n is a natural number greater than or equal to k) from the amplitude of a received signal for judging which of k values (k is a natural number not smaller than 2) is a received data value; a judgment timing output unit for outputting m judgment timings (m is a natural number) in a one-bit section of the received signal; a data judgment unit for comparing the received signal with each of the n threshold values at the judgment timing, determining which of the k values is the value of the received signal compared with each of the threshold values, and providing a received data value corresponding to the threshold value at the judgment timing; and a majority-rule judgment unit for deciding, by majority rule, on the received data values in the one-bit section obtained as judgments by the data judgment unit and outputting the majority of the received data values as data in the one-bit section.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a view illustrating an overview of a data receiving apparatus.

FIG. 2 is a functional block diagram of the data receiving apparatus.

FIG. 3 is a functional block diagram of a level judgment block.

FIG. 4 is a view illustrating the operation of the level judgment block shown in FIG. 3.

FIG. 5 is a view illustrating the operation of the level judgment block shown in FIG. 3 when noise shorter than time ta occurs.

FIG. 6 is a view illustrating the operation of the level judgment block shown in FIG. 3 when noise occurs during peak level detection.

FIG. 7 is a view illustrating threshold values of a threshold value control block.

FIG. 8 is a functional block diagram of a timing control block.

FIG. 9 is a view illustrating the operation of the timing control block shown in FIG. 8.

FIG. 10 is a view showing the relationship between levels of received data and judgment timings.

FIG. 11 is a view showing the relationship between the levels of received data and judgment timings when a timing adjustment threshold value is a fixed value.

FIG. 12 is a view illustrating the operation of a data judgment block.

FIG. 13 is a view illustrating the operation of the data receiving apparatus.

FIG. 14 is a view illustrating specific values of signals.

FIG. 15 is a view illustrating a judgment operation of a conventional data receiving apparatus that judges whether a signal is ‘1’ or ‘0’ in accordance with a threshold value.

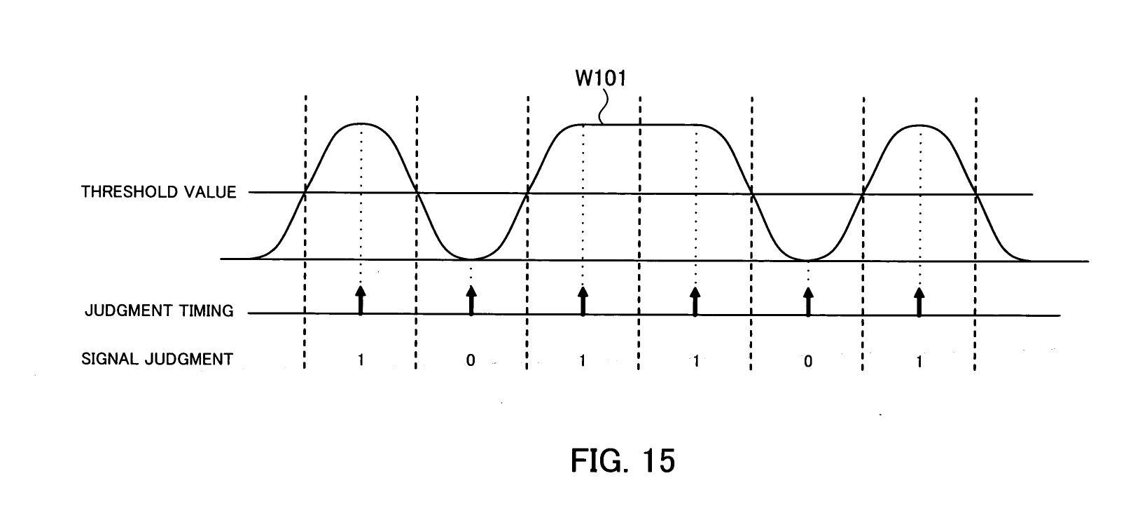

FIG. 16 is a view illustrating a judgment operation of a conventional data receiving apparatus using a threshold band.

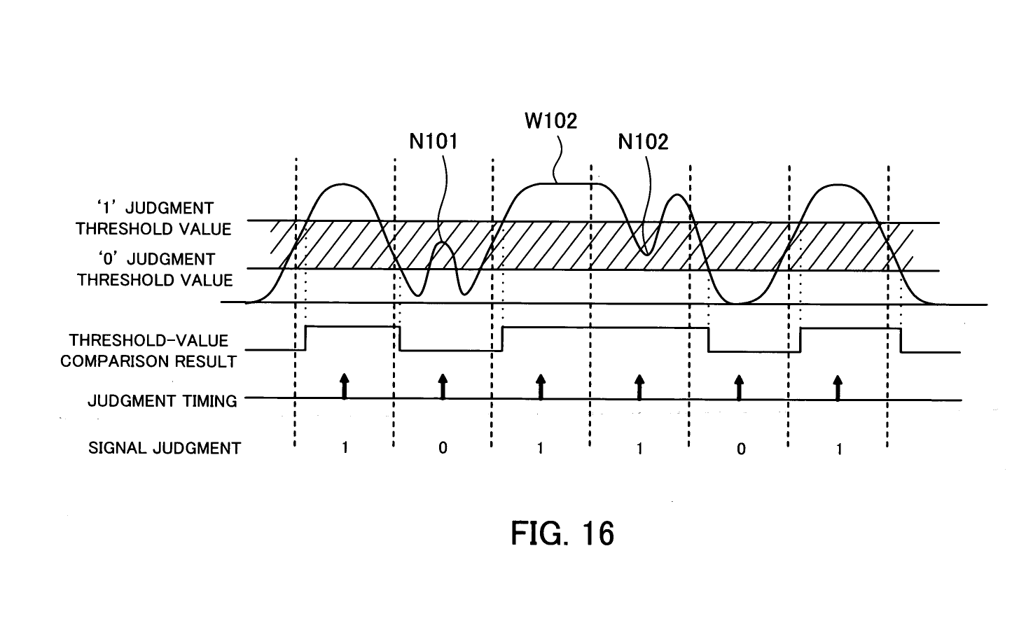

FIG. 17 is a view illustrating an example of misjudgment resulting from noise exceeding the threshold band.

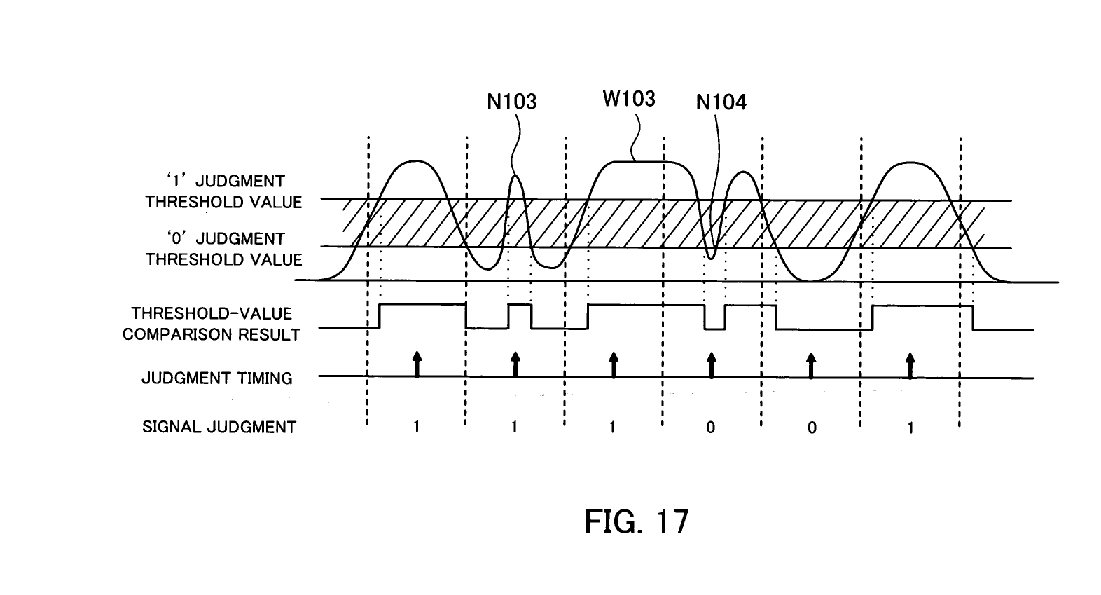

FIG. 18 is a view illustrating an example of signal misjudgment depending on the signal level.

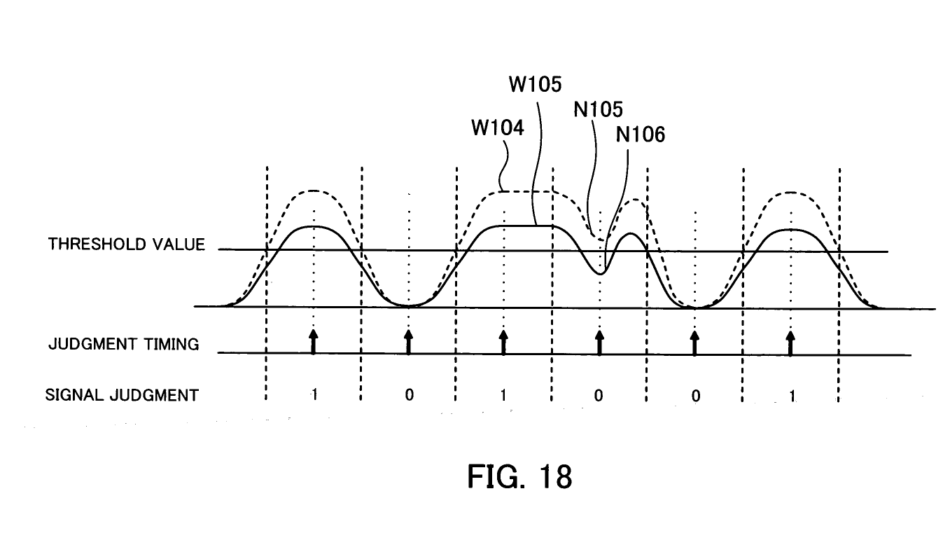

FIG. 19 is a view illustrating an example where noise is added at judgment timing.

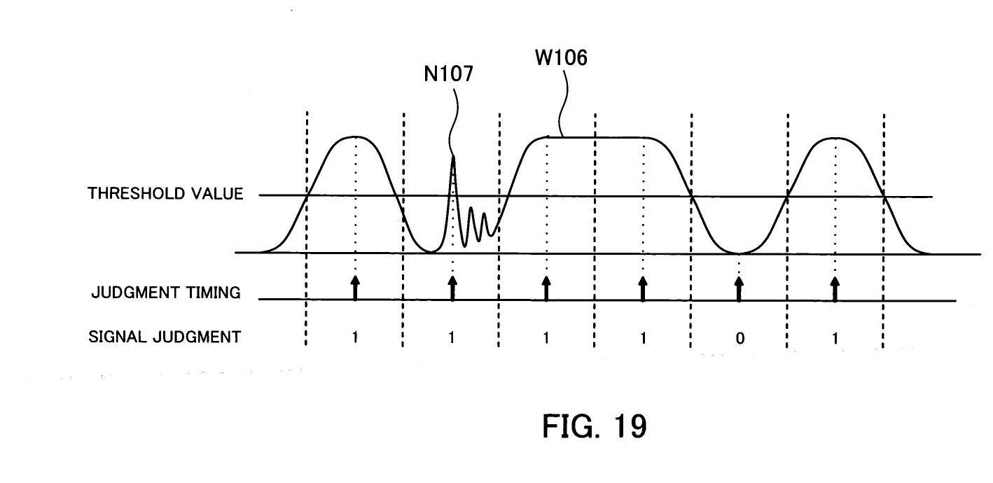

### DESCRIPTION OF THE PREFERRED EMBODIMENTS

The principle of the present invention will be described below in detail with reference to the drawings.

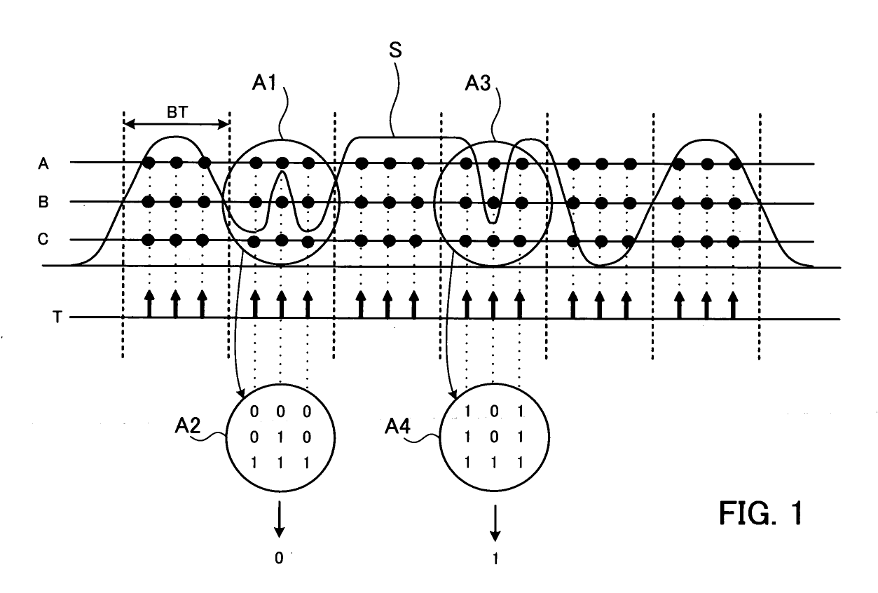

FIG. 1 is a view illustrating an overview of a data receiving apparatus. The data receiving apparatus, not shown, includes a threshold value calculation unit, a judgment timing output unit, a data judgment unit, and a majority-rule judgment unit. The figure shows a received signal S input to the data receiving apparatus. The data statuses of the received signal S are shown in each one-bit section BT.

To judge the received data value to be any of k values (k is a natural number greater than or equal to 2), the threshold value calculation unit of the data receiving apparatus calculates n different threshold values (n is a natural number greater than or equal to k) from the amplitude of the received signal. As shown in the figure, for instance, the threshold value calculation unit calculates threshold values A, B, and C (n=3) from the amplitude of the received signal S, for judging the received data value to be either of two values (k=2), ‘1’ and ‘0’.

The judgment timing output unit outputs m judgment timings (m is a natural number) in a one-bit section BT of the received signal. For instance, the judgment timing output unit outputs three judgment timings T (m=3) in each one-bit section BT of the received signal, as shown in the figure.

The data judgment unit compares the received signal S with each of the n threshold values at each judgment timing, judges which of the k values matches the status of the received signal S compared with the threshold value, and outputs the received data value corresponding to the threshold value obtained at the judgment timing. For instance, the data judgment unit compares the received signal S with each of the threshold values A, B, and C at the judgment timing T, as shown in the figure, and judges which of the two values, ‘1’ and ‘0’, is the status of the received signal S compared with each of the threshold values A, B, and C. Then, the data judgment unit outputs the received data value ‘1’ or ‘0’ obtained in comparison with each of the threshold values A, B, and C at the judgment timing T. An area A2 in the figure shows the judged ‘1’ and ‘0’ statuses of the received signal shown in an area A1, and an area A4 shows the judged ‘1’ and ‘0’ statuses of the received signal S shown in an area A3.

The majority-rule judgment unit decides, by majority rule, on the received data values judged in a one-bit section BT by the data judgment unit and outputs the majority of the received data values as the data in the one-bit section BT. For instance, the majority-rule judgment unit decides, by majority rule, on the ‘1’ and ‘0’ statuses of the received data judged by the data judgment unit and outputs the majority of the ‘1’ and ‘0’ statuses as the status of the received signal S in the one-bit section BT, as shown in the figure.

Suppose that the received signal S originally shows the ‘0’ status in the area A1, where noise showing the ‘1’ status is added. The corresponding area A2, however, shows four ‘1’ states and five ‘0’ states, that is, the majority is ‘0’. Accordingly, the majority-rule judgment unit can correctly judge that the received signal S is in the ‘0’ status in the area A1. Suppose that the received signal S originally shows the ‘1’ status in the area A3, where noise showing the ‘0’ status is added. The corresponding area A4 shows seven ‘1’ statuses and two ‘0’ statuses, that is, the majority is ‘1’. Accordingly, the majority-rule judgment unit can correctly judge that the received signal S is in the ‘1’ status in the area A3.

The values of the received signal in a one-bit section are judged in accordance with a plurality of threshold values at a plurality of judgment timings, and the results of judgment are decided on by majority rule. This makes it possible to judge data correctly even if noise is added to the received signal and to reduce bit errors owing to noise.

An embodiment of the present invention will be described below in detail with reference to the drawings.

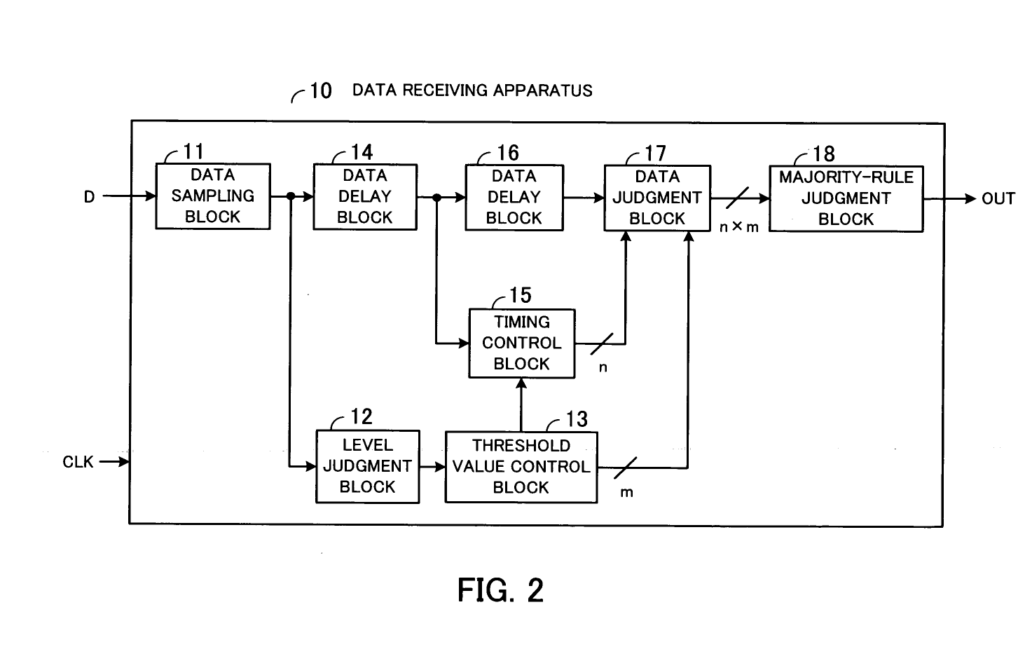

FIG. 2 is a functional block diagram of a data receiving apparatus 10 according to an embodiment of the present invention. As shown in the figure, the data receiving apparatus 10 includes a data sampling block 11, a level judgment block 12, a threshold value control block 13, data delay blocks 14 and 16, a timing control block 15, a data judgment block 17, and a majority-rule judgment block 18.

The data receiving apparatus 10 is mounted on communication apparatuses such as a repeater unit. The data receiving apparatus 10 receives data (signal) sent from another communication apparatus as received data D, judges whether the data is ‘1’ or ‘0’, and outputs the judgment to another circuit block in the communication apparatus. The data receiving apparatus 10 also receives a sampling clock CLK having a faster bit rate than the input received data D. The functions shown in the figure operate in synchronization with the sampling clock CLK.

The data sampling block 11 over-samples the received data D at the rate of the sampling clock CLK. The data sampling block 11 outputs the over-sampled received data D to the level judgment block 12 and the data delay block 14.

The level judgment block 12 obtains the amplitude range of the received data D and outputs it to the threshold value control block 13. If the ‘0’ status of the received data D is the ground level, the level judgment block 12 outputs the maximum voltage of the received data D to the threshold value control block 13. When the ‘0’ status of the received data D is the ground level, the amplitude range of the received data D can be obtained by outputting the maximum value of the received data D.

The threshold value control block 13 calculates a plurality of threshold values (m threshold values) needed to judge whether the received data D is ‘1’ or ‘0’, from the amplitude range of the received data D output from the level judgment block 12. The threshold values are obtained by dividing the amplitude range output from the level judgment block 12 by m+1, for instance. The threshold value control block 13 outputs the m calculated threshold values to the data judgment block 17. The threshold value control block 13 also outputs one of the calculated threshold values to the timing control block 15 (this threshold value will be referred to as a timing adjustment threshold value). It is preferred that the timing adjustment threshold value, which will be described later in detail, output to the timing control block 15 be the central value among the calculated threshold values.

The data delay block 14 delays the received data D output from the data sampling block 11 by the time required for the processing performed in the level judgment block 12 and the threshold value control block 13, and outputs the delayed data to the timing control block 15 and the data delay block 16. Now, the received data D input to the timing control block 15 matches the received data D used as a basis of calculation of the timing adjustment threshold value output from the threshold value control block 13.

The timing control block 15 generates judgment timing for judging whether the received data D is ‘1’ or ‘0’, from the received data D output from the data delay block 14 and the timing adjustment threshold value output from the threshold value control block 13. The timing control block 15 generates a plurality of judgment timings (n judgment timings) in a single one-bit section of the received data D so that a plurality of judgments can be made in the one-bit section of the received data D. The timing control block 15 outputs the generated judgment timings to the data judgment block 17.

The data delay block 16 delays the received data D output from the data delay block 14 by the time required for the processing performed in the timing control block 15 and outputs the delayed data to the data judgment block 17. Now, the received data D input to the data judgment block 17 matches the received data D to be judged at the judgment timings output from the timing control block 15.

The data judgment block 17 makes a 1/0 judgment by comparing the received data D output from the data delay block 16 with the plurality of threshold values output from the threshold value control block 13 at the judgment timings output from the timing control block 15. For instance, suppose that three threshold values A, B, and C are output from the threshold value control block 13, the threshold values A, B, and C having the relationship of A<B<C. If the received data D exceed the threshold values A and B and do not exceed the threshold value C at a judgment timing, the data judgment block 17 judges that the received data D have signal statuses ‘1’, ‘1’, ‘0’ at the judgment timing. If n judgment timings are output in a single one-bit section of the received data D and m threshold values are provided, the data judgment block 17 outputs n×m signal statuses in the one-bit section of the received data D.

The majority-rule judgment block 18 decides, by majority rule, on the plurality of signal statuses output from the data judgment block 17 in the one-bit section of the received data D. If the ‘1’ statuses outnumber the ‘0’ statuses in a one-bit section of the received data D, the signal status in the one-bit section is determined to be ‘1’, and an OUT signal indicating the result of judgment is output. If the ‘0’ statuses outnumber the ‘1’ statuses, the signal status in the one-bit section is determined to be ‘0’, and an OUT signal indicating the result of judgment is output.

Detailed descriptions of the level judgment block 12, the threshold value control block 13, the timing control block 15, the data judgment block 17, and the majority-rule judgment block 18 shown in FIG. 2 will follow. First, the level judgment block 12 will be described.

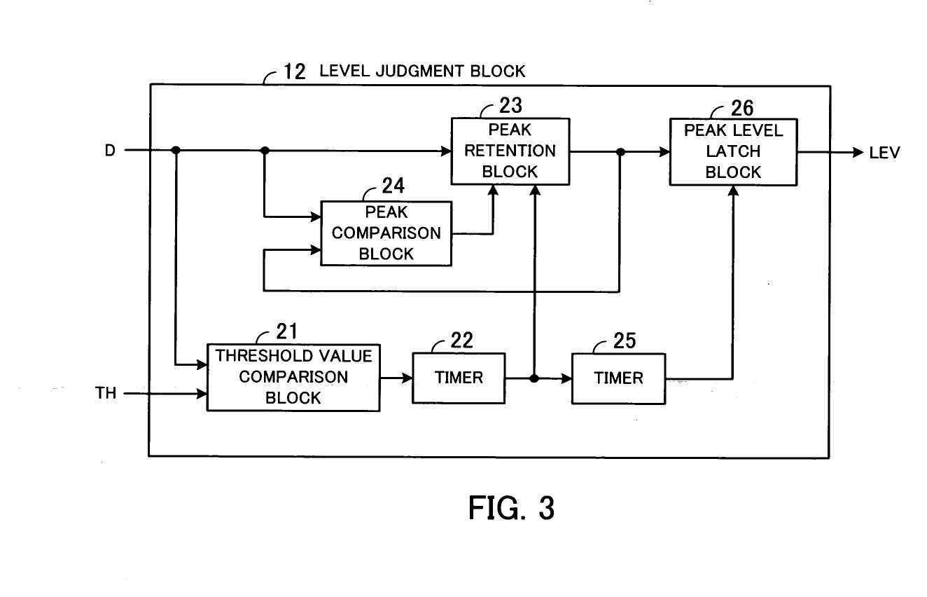

FIG. 3 is a functional block diagram of the level judgment block 12. As shown in the figure, the level judgment block 12 includes a threshold value comparison block 21, timers 22 and 25, a peak retention block 23, a peak comparison block 24, and a peak level latch block 26.

The threshold value comparison block 21 receives the received data D output from the data sampling block 11 and a lowest threshold value TH. The threshold value comparison block 21 compares the received data D with the lowest threshold value TH to see whether the data exceeds the threshold value and outputs the result of comparison to the timer 22. The lowest threshold value TH is the lowest level of the received data D that can be input to the data receiving apparatus 10. In other words, the threshold value comparison block 21 allows the received data D exceeding the lowest threshold value to be input (this will be described later in further detail).

The timer 22 performs a timer operation while a signal indicating that the received data D have exceeded the lowest threshold value TH is being received from the threshold value comparison block 21. After a lapse of time ta, the timer 22 outputs a signal indicating the lapse of time ta to the peak retention block 23 and the timer 25.

When the signal indicating that time ta has elapsed is received from the timer 22, the peak retention block 23 receives an update signal from the peak comparison block 24 and holds the received data D. The peak retention block 23 outputs the held received data D to the peak comparison block 24 and the peak level latch block 26.

The peak comparison block 24 compares the received data D held by the peak retention block 23 and the received data D output from the data sampling block 11. If the received data D output from the data sampling block 11 is greater than the received data D held by the peak retention block 23, the peak comparison block 24 outputs an update signal to the peak retention block 23.

When a signal indicating that time ta has elapsed is received from the timer 22, the timer 25 starts a timer operation. After a lapse of time tb, the timer 25 outputs a signal indicating the lapse of time tb to the peak level latch block 26.

When the signal indicating that time tb has elapsed is received from the timer 25, the peak level latch block 26 fixes the peak value output from the peak retention block 23 and outputs it as the maximum signal level LEV of the received data D to the threshold value control block 13.

The operation of the level judgment block 12 will be described next.

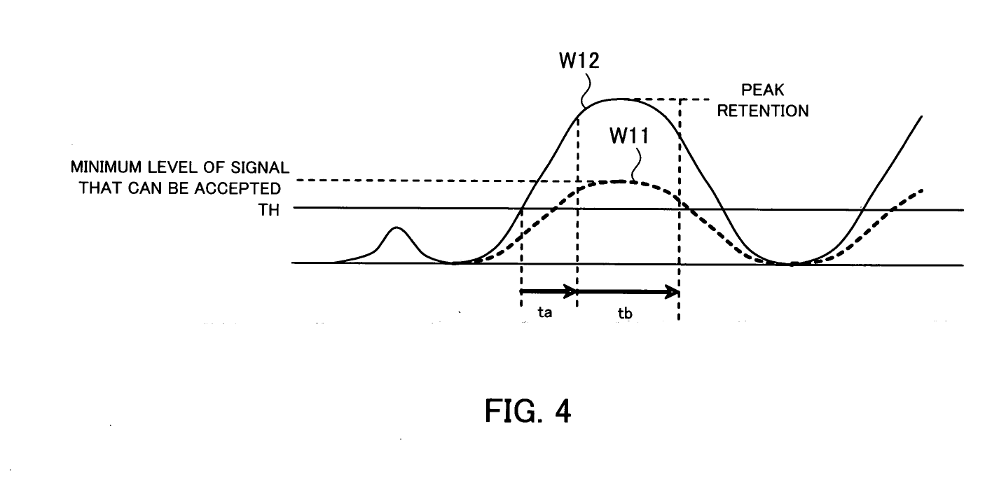

FIG. 4 is a view illustrating the operation of the level judgment block 12, shown in FIG. 3. Generally, the specifications of signals that can be input to electronic equipment are predetermined in a design phase. A signal waveform W11 shown in the figure represents the waveform of minimum received data D that can be input to the data receiving apparatus 10, specified in the design phase. The lowest threshold value TH should be determined to be lower than the shown signal waveform 11 so that the signal waveform W11 can be accepted. The minimum level of the received data D can be determined, for example, from the range of variation in input level of the received data D, the amount of signal loss in the equipment, or the like. The signal waveform W12 represents the waveform of the received data D actually input to the level judgment block 12.

As described with reference to FIG. 3, when the received data D exceeds the lowest threshold value TH, the threshold value comparison block 21 outputs a signal indicating this comparison result to the timer 22. If the signal level of the received data D is lower than the lowest threshold value TH, the signal is regarded as noise, and the timer 22 is not activated. If the signal level of the received data D exceeds the lowest threshold value TH, the timer 22 is activated. When the time counted by the timer 22 reaches ta, the peak retention block 23 is activated to start holding the peak level of the signal waveform W12, and the timer 25 is activated at the same time. When the time counted by the timer 25 reaches tb, the peak level latch block 26 fixes the peak value held by the peak retention block 23 and outputs the signal level LEV to the threshold value control block 13.

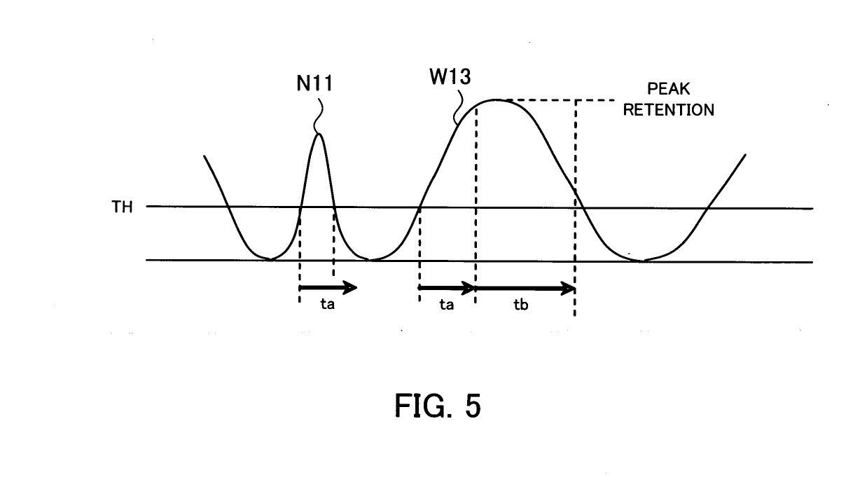

FIG. 5 is a view illustrating the operation of the level judgment block 12, shown in FIG. 3, performed when noise shorter than time ta occurs. The signal waveform W13 represents the waveform of received data input to the level judgment block 12. Noise N11 represents noise added to the signal waveform W13.

When the level of noise N11 exceeds the lowest threshold value TH, as shown in the figure, the timer 22 is activated. If noise N11 does not continue for the time ta, counted by the timer 22, neither the peak retention block 23 nor the timer 25 is activated by the timer 22, and peak retention processing is not performed. In other words, the signal waveform W13 is determined to be a signal if it keeps exceeding the lowest threshold value TH for time ta. Because the timer 22 drives the peak retention block 23 and the timer 25 after a lapse of time ta, instantaneous noise such as the noise N11 can be eliminated.

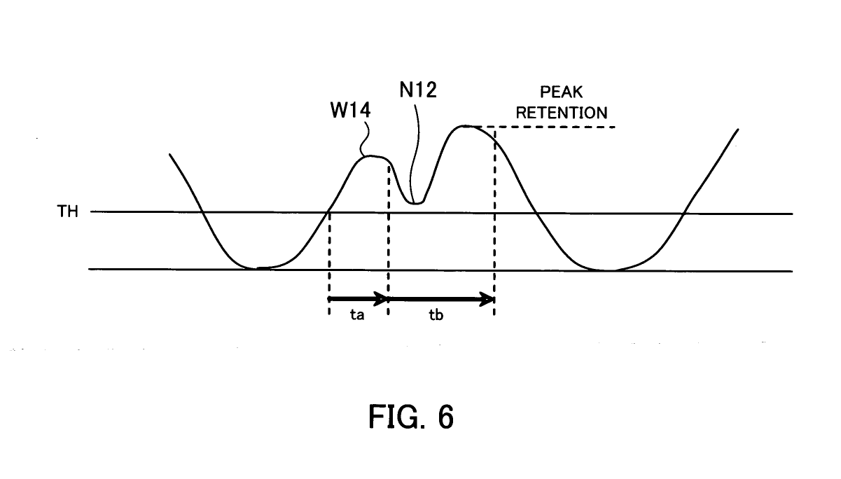

FIG. 6 is a view illustrating the operation of the level judgment block 12, shown in FIG. 3, performed when noise occurs during peak level detection. A signal waveform W14 represents the waveform of received data D input to the level judgment block 12. Noise N12 represents noise added to the signal waveform W14.

When the time ta elapses after the signal waveform W14 has exceeded the lowest level threshold TH, the timer 25 is activated to start counting time tb, as shown in the figure. The peak retention block 23 is also activated. The peak retention block 23 keeps the peak level of the signal waveform W14 for time tb even if the noise N12 is added to the signal waveform W14, so that the peak level can be detected without being affected by instantaneous noise having a period shorter than time tb.

As the durations of time ta counted by the timer 22 and time tb of the timer 25 increase, the effect of noise can be reduced. However, the duration of ta+tb should not exceed the one-bit section (bit cycle) of the received data D. The bit rate of the received data D is known in advance, and the time ta and the time tb must be determined within the bit cycle, depending on a desired degree of noise reduction. The time tb must also be determined in consideration of the time at which the received data D reach the peak level. If the time tb is shorter than the time required for the received data D to reach the peak level, the peak level of the received data D cannot be detected.

As has been described above, the received data D is regarded as noise if its level does not exceed the lowest threshold value TH or if the level does not keep exceeding the lowest threshold value TH for the time ta or longer. The peak level is retained for the time tb. Accordingly, the level judgment block 12 can detect the peak level of the received data D without being affected by noise.

The peak retention block 23, shown in FIG. 3, outputs the minimum input level of the received data D, determined in the design phase, as the initial value.

The threshold value control block 13 will next be described.

The threshold value control block 13 calculates threshold values used in judging whether the received data D is ‘1’ or ‘0’, from the peak level (amplitude range) of the received data D, output from the level judgment block 12. To be more specific, the threshold values can be obtained by multiplying the peak level by {n/(m+1)}, where m is the number of threshold values and n is an integer in the range of 1 to m.

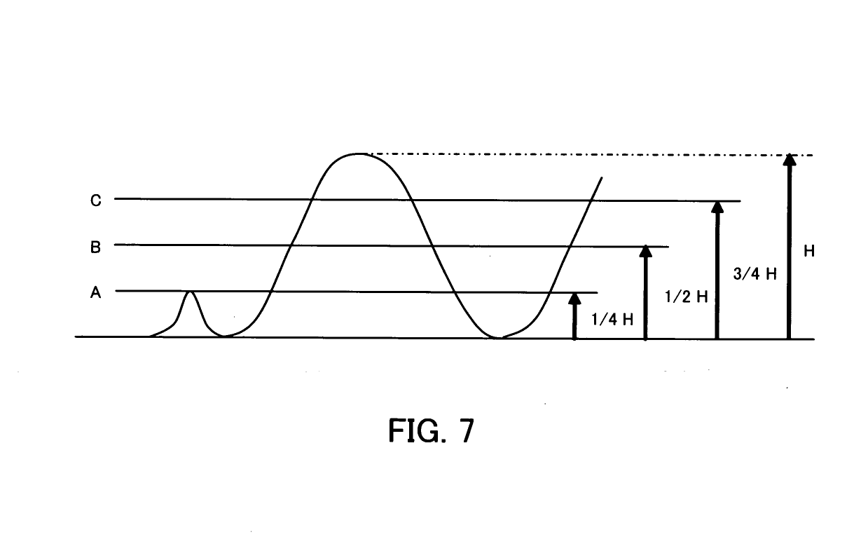

FIG. 7 is a view illustrating threshold values calculated by the threshold value control block 13. In the figure, three threshold values A, B, and C are provided to judge whether the received data D is ‘1’ or ‘0’, and the peak level of the received data D is denoted as H. In the shown example, the m value is 3, the n values are 1, 2, and 3, and the threshold values A, B, and C can be expressed as (¼)H, (½)H, and (¾)H, respectively.

The threshold values A, B, and C are calculated by dividing the peak level of the received data D evenly in the example shown in FIG. 7, but the threshold values may be determined in a different method. The threshold values A, B, and C may be determined not by dividing the peak level of the received data D evenly. However, for balanced 1/0 judgment on the received data D, it is preferred to determine the threshold values by dividing the peak level evenly. As has been described earlier, the majority-rule judgment block 18 decides, by majority rule, on the signal statuses output from the data judgment block 17 in the one-bit section of the received data D. Therefore, the number of threshold values should be an odd number.

The timing control block 15 will now be described.

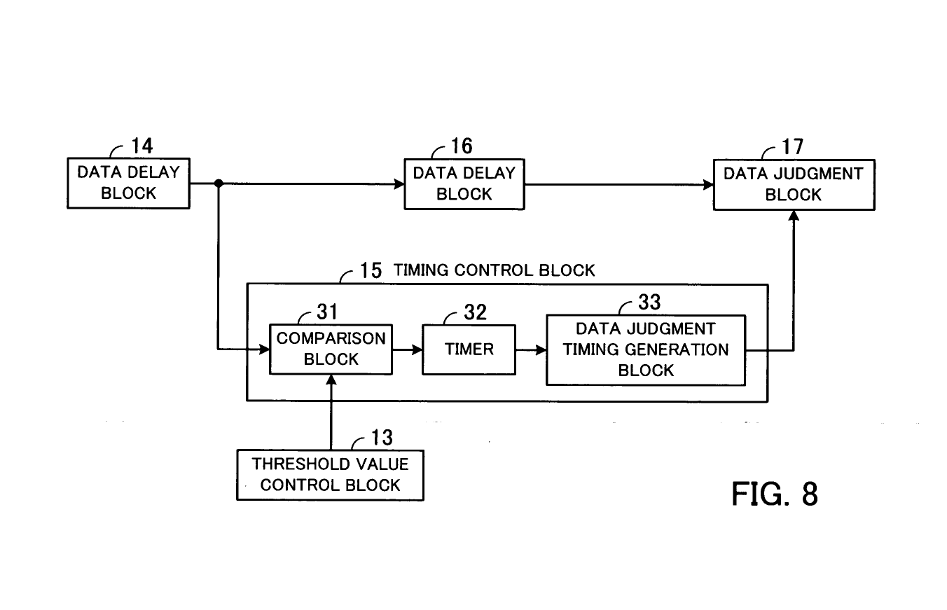

FIG. 8 is a functional block diagram of the timing control block 15. The figure also shows the threshold value control block 13, the data delay blocks 14 and 16, and the data judgment block 17, shown in FIG. 2. As shown in FIG. 8, the timing control block 15 includes a comparison block 31, a timer 32, and a data judgment timing generation block 33.

The comparison block 31 receives the received data D output from the data delay block 14 and the timing adjustment threshold value output from the threshold value control block 13. The comparison block 31 compares the received data D with the timing adjustment threshold value and, when the received data D exceeds the timing adjustment threshold value, outputs a signal indicating that the received data D exceeds the value to the timer 32.

The timer 32 performs a timer operation while it is receiving the signal indicating that the received data D have exceeded the timing adjustment threshold value from the comparison block 31. After a lapse of time t0, the timer 32 outputs a signal indicating the lapse of time t0 to the data judgment timing generation block 33. The delay time of the data delay block 16 should match the time t0.

When the signal indicating that the time t0 has elapsed is received from the timer 32, the data judgment timing generation block 33 generates a plurality of judgment timings for judging whether the received data D in a one-bit section is ‘1’ or ‘0’. The data judgment timing generation block 33 outputs the generated judgment timings to the data judgment block 17.

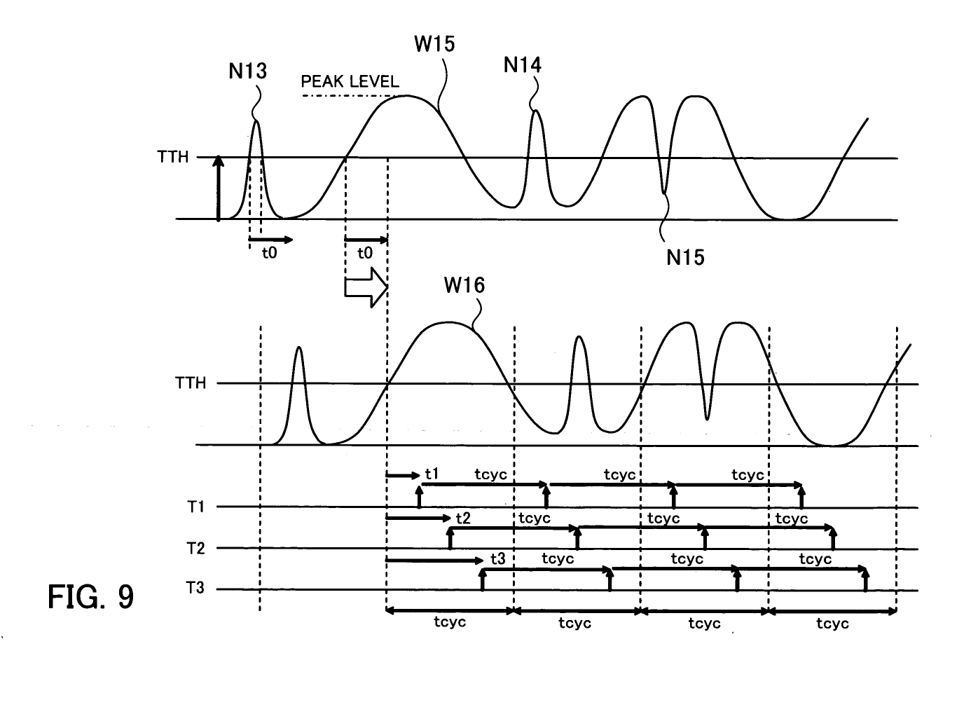

FIG. 9 is a view illustrating the operation of the timing control block 15, shown in FIG. 8. A signal waveform W15 represents the waveform of the received data D input to the comparison block 31. Noise N13 to N15 represent noise added to the signal waveform W15.

As shown in the figure, when the level of noise N13, added to the signal waveform W15, exceeds a timing adjustment threshold value TTH, the timer 32 is activated. However, noise N13 does not continue for the time t0, counted by the timer 32, the data judgment timing generation block 33 is not activated by the timer 32, and no judgment timing is generated. In other words, when the signal waveform W15 keeps exceeding the timing adjustment threshold value TTH for the time t0, the signal waveform W15 is determined to be a signal. Because the data judgment timing generation block 33 is driven when the time t0 counted by the timer 32 has elapsed, the effect of instantaneous noise such as noise N13 can be avoided. The timing adjustment threshold value TTH is the central value among the threshold values calculated by the threshold value control block 13, as has been described earlier. An odd number of threshold values are calculated, as described earlier. Accordingly, the timing adjustment threshold value TTH is ½ of the peak level of the signal waveform W15.

If the signal waveform W15 keeps exceeding the timing adjustment threshold value TTH for a period longer than time t0, the data judgment timing generation block 33 generates judgment timings T1 to T3, starting from time t0. The judgment timing T1 is generated when a time t1 has elapsed since the time t0, as shown in the figure, and subsequent timings T1 are automatically generated at intervals of a bit cycle tcyc of the received data D. The judgment timing T2 is generated when a time t2 has elapsed since the time t0, as shown in the figure, and subsequent timings T2 are automatically generated at intervals of the bit cycle tcyc of the received data D. The judgment timing T3 is generated when a time t3 has elapsed since the time t0, as shown in the figure, and subsequent timings T3 are automatically generated at intervals of the bit cycle tcyc of the received data D. There is a relationship of t1<t2<t3. It is preferred that the judgment timings T1 to T3 be output in such a manner that they divide the bit cycle of the received data D evenly, so that balanced 1/0 judgment can be made. An odd number of judgment cycles should be output in the bit cycle for the majority-rule processing in the majority-rule judgment block 18. Since the judgment timings T1 to T3 are generated and output after a lapse of time t0, the received data D is delayed by the time to by the data delay block 16, as represented by a signal waveform W16.

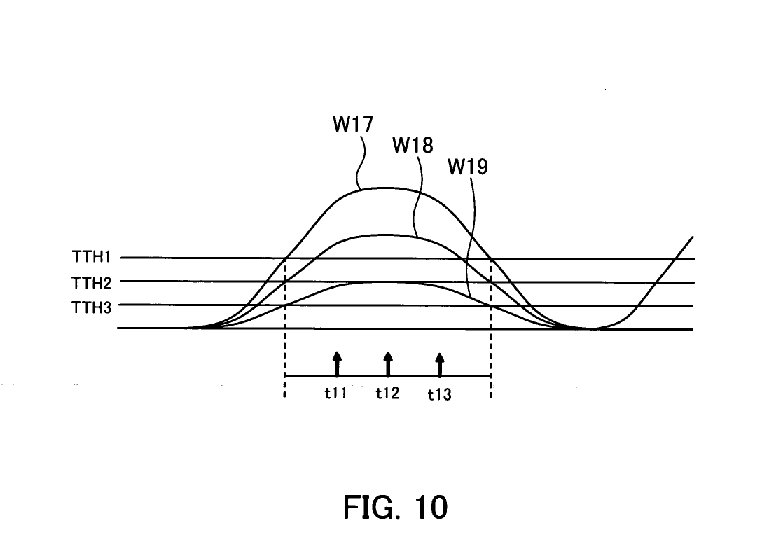

FIG. 10 is a view showing the relationship between the levels of received data and judgment timings. The figure shows signal waveforms W17 to W19 of the received data D, having different peak levels. The figure also shows timing adjustment threshold values TTH1 to TTH3, which correspond to the signal waveforms W17 to W19, respectively. Timings t11 to t13 where judgment timings are output are also shown.

The timing adjustment threshold values TTH1 to TTH3 are calculated from the peak level of the received data, as has been described earlier. As the peak level increases, the timing adjustment threshold value increases, as indicated by TTH1 for the signal waveform W17. As the peak level decreases, the timing adjustment threshold value decreases, as indicated by TTH3 for the signal waveform W19. Judgment timings t11 to t13 are always output at regular intervals, as shown in the figure, regardless of the peak levels of the signal waveforms W17 to W19.

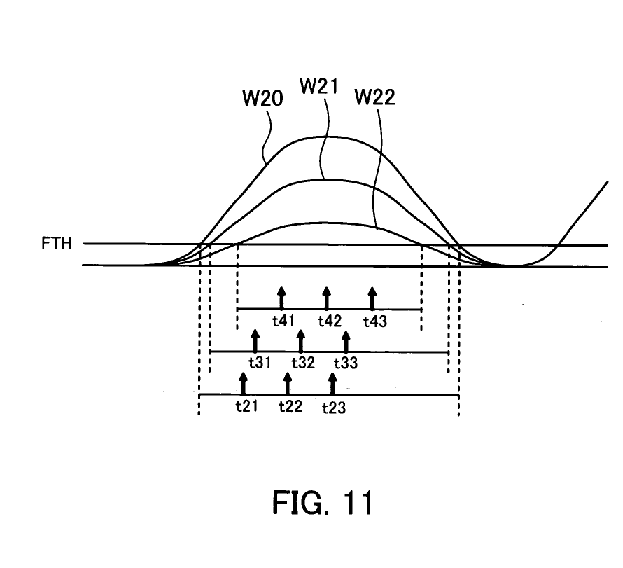

FIG. 11 is a view showing the relationship between the levels of received data and judgment timings when the timing adjustment threshold value is a fixed value. The figure shows signal waveforms W20 to W22 of the received data D, having different peak levels. A fixed timing adjustment threshold value FTH is also shown. The figure also shows timings t21 to t23, t31 to t33, and t41 to t43 where judgment timings are output.

If the timing adjustment threshold value FTH is a fixed value, the output of judgment timings for the signal waveforms W21 and W22, having small peak levels, is delayed in comparison with the signal waveform W20, having a larger peak level. This occurs because the signal waveform having a small peak level requires a longer time to exceed the timing adjustment threshold value FTH. If the timing adjustment threshold value is a fixed value, the judgment timings vary with the peak level of the received data D, which could make the judgment by priority rule, which will be described later, unbalanced.

The data judgment block 17 will next be described.

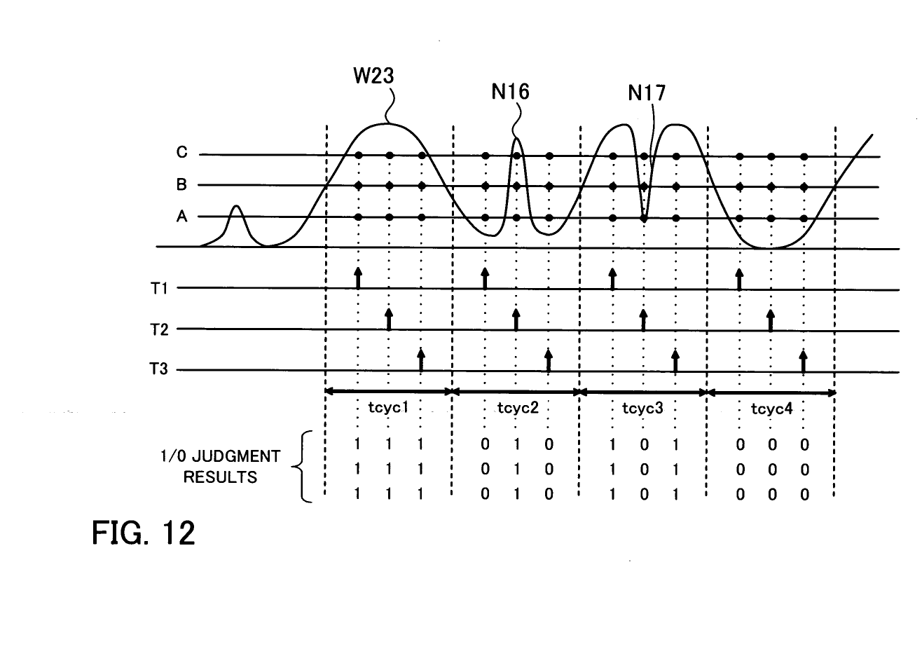

FIG. 12 is a view illustrating the operation of the data judgment block 17. A signal waveform W23 shown in the figure represents the signal waveform of the received data D input from the data delay block 16 to the data judgment block 17. Noise N16 and N17 are added to the signal waveform W23. Threshold values A, B, and C are input from the threshold value control block 13 to the data judgment block 17. Judgment timings T1 to T3 are input from the timing control block 15 to the data judgment block 17.

The data judgment block 17 compares the signal waveform W23 of the received data D output from the data delay block 16 with the threshold values A, B, and C at the judgment timings T1 to T3 output from the timing control block 15. The 1/0 judgment on the signal waveform W23 is made at points where arrows marking the judgment timings T1 to T3 intersect the threshold values A, B, and C in the figure. For instance, the signal waveform W23 is greater than the threshold values A, B, and C at the judgment timing T1 in a shown bit cycle tcyc1. Therefore, the signal statuses of the signal waveform W23 at the judgment timing T1 in the bit cycle tcyc1 are ‘1’, ‘1’, ‘1’. The signal statuses of the signal waveform W23 at the judgment timing T2 in the bit cycle tcyc1 are ‘1’, ‘1’, ‘1’, and the signal statuses of the signal waveform W23 at the judgment timing T3 in the bit cycle tcyc1 are ‘1’, ‘1’, ‘1’.

The signal statuses of the signal waveform W23 at the judgment timing T1 in the bit cycle tcyc2, where noise N16 is added to the signal waveform W23, are ‘0’, ‘0’, ‘0’; the signal statuses of the signal waveform W23 at the judgment timing T2 in the bit cycle tcyc2 are ‘1’, ‘1’, ‘1’; and the signal statuses of the signal waveform W23 at the judgment timing T3 in the bit cycle tcyc2 are ‘0’, ‘0’, ‘0’. The signal statuses of the signal waveform W23 at the judgment timing T1 in the bit cycle tcyc3, where noise N17 is added to the signal waveform W23, are ‘1’, ‘1’, ‘1’; the signal statuses of the signal waveform W23 at the judgment timing T2 in the bit cycle tcyc3 are ‘0’, ‘0’, ‘0’; and the signal statuses of the signal waveform W23 at the judgment timing T3 in the bit cycle tcyc3 are ‘1’, ‘1’, ‘1’.

The majority-rule judgment block 18 will next be described.

The majority-rule judgment block 18 decides, by majority rule, on the plurality of signal statuses of the received data D in a one-bit section, output from the data judgment block 17. In the example shown in FIG. 12, the signal status in the bit cycle tcyc1 is determined to be ‘1’ because there are nine ‘1’ statuses; the signal status in the bit cycle tcyc2 is determined to be ‘0’ because there are three ‘1’ statuses and six ‘0’ statuses; the signal status in the bit cycle tcyc3 is determined to be ‘1’ because there are six ‘1’ statuses and three ‘0’ statuses. Even if the noise N16 shown in the figure is added to the signal waveform W23, which is originally ‘1’ in the bit cycle tcyc2, the signal status can be judged correctly to be ‘0’ in the bit cycle. Even if the noise N17 shown in the figure is added to the signal waveform W23, which is originally ‘1’ in the bit cycle tcyc3, the signal status can be judged correctly to be ‘1’ in the bit cycle. Bit errors owing to noise can be reduced by obtaining the signal statuses of the received data D at a plurality of points and deciding on them by majority rule.

The operation of the data receiving apparatus 10, shown in FIG. 2, will next be described.

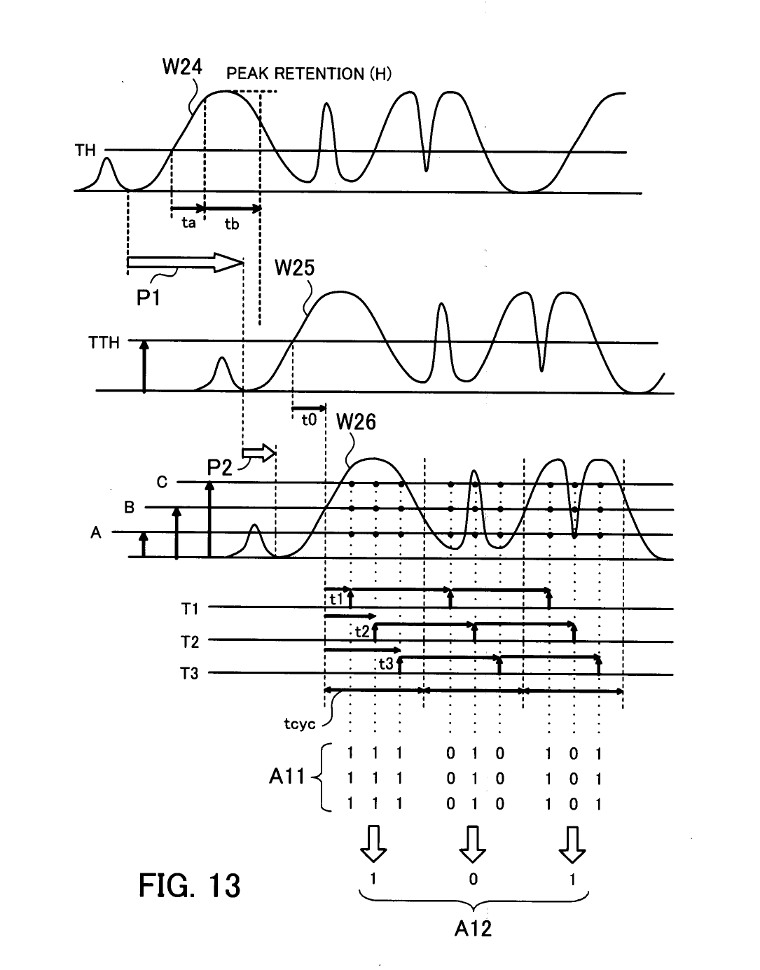

FIG. 13 is a view illustrating the operation of the data receiving apparatus 10. A signal waveform W24 shown in the figure represents the waveform of received data D input to the level judgment block 12 and the data delay block 14. If the signal waveform 24 keeps exceeding the lowest threshold value TH for the time ta or longer, the level judgment block 12 judges that the signal waveform W24 is not noise but a signal and starts retaining the peak level. The level judgment block 12 retains the peak level for the time tb and outputs the retained peak level to the threshold value control block 13.

The threshold value control block 13 calculates threshold values A, B, and C and a timing adjustment threshold value TTH, from the peak level of the signal waveform W24 output from the level judgment block 12. The magnitudes of the threshold values A, B, and C and the timing adjustment threshold value TTH can be expressed as (¼)H, (½)H, (¾)H, and (½)H, respectively, where H is the value of the peak level. The threshold value control block 13 outputs the threshold values A, B, and C to the data judgment block 17 and the timing adjustment threshold value TTH to the timing control block 15.

The signal waveform W24 input to the data delay block 14 is delayed by the time required for the processing performed in the level judgment block 12 and the threshold value control block 13, as indicated by an arrow P1 shown in the figure. A signal waveform W25 represents the waveform of the received data D delayed by the data delay block 14. The signal waveform W25, delayed by the data delay block 14, is output to the timing control block 15 and the data delay block 16.

The timing control block 15 compares the signal waveform W25 with the timing adjustment threshold value TTH output from the threshold value control block 13, as shown in the figure. If the signal waveform W25 keeps exceeding the timing adjustment threshold value TTH for a period longer than the time t0, judgment timings T1 to T3 are generated. As shown in the figure, the judgment timing T1 is generated when the time t1 has elapsed since the time t0, and subsequent timings T1 are generated at intervals of the bit cycle tcyc of the received data D. The judgment timing T2 is generated when the time t2 has elapsed since the time t0, and subsequent timings T2 are generated at intervals of the bit cycle tcyc of the received data D. The judgment timing T3 is generated when the time t3 has elapsed from the time t0, and subsequent timings T3 are generated at intervals of the bit cycle tcyc of the received data D. The judgment timings T1 to T3 are output to the data judgment block 17.

The signal waveform W25 input to the data delay block 16 is delayed by the period required for the processing performed in the timing control block 15, as indicated by an arrow P2 shown in the figure. A signal waveform W26 represents the waveform of the received data D delayed by the data delay block 16. The signal waveform W26, delayed by the data delay block 16, is output to the data judgment block 17.

The data judgment block 17 makes 1/0 judgments by comparing the received data D output from the data delay block 16 with the threshold values A, B, and C output from the threshold value control block 13 at the judgment timings T1 to T3 output from the timing control block 15. An area A11 in the figure shows the 1/0 judgments on the signal waveform W26. The majority-rule judgment block 18 decides, by majority rule, on the judgments formed by the data judgment block 17 and judges whether the signal waveform W26 is ‘1’ or ‘0’ in each one-bit section, as shown in an area A12. Whether the received data is ‘1’ or ‘0’ is judged as described above.

Specific values of signals will next be described.

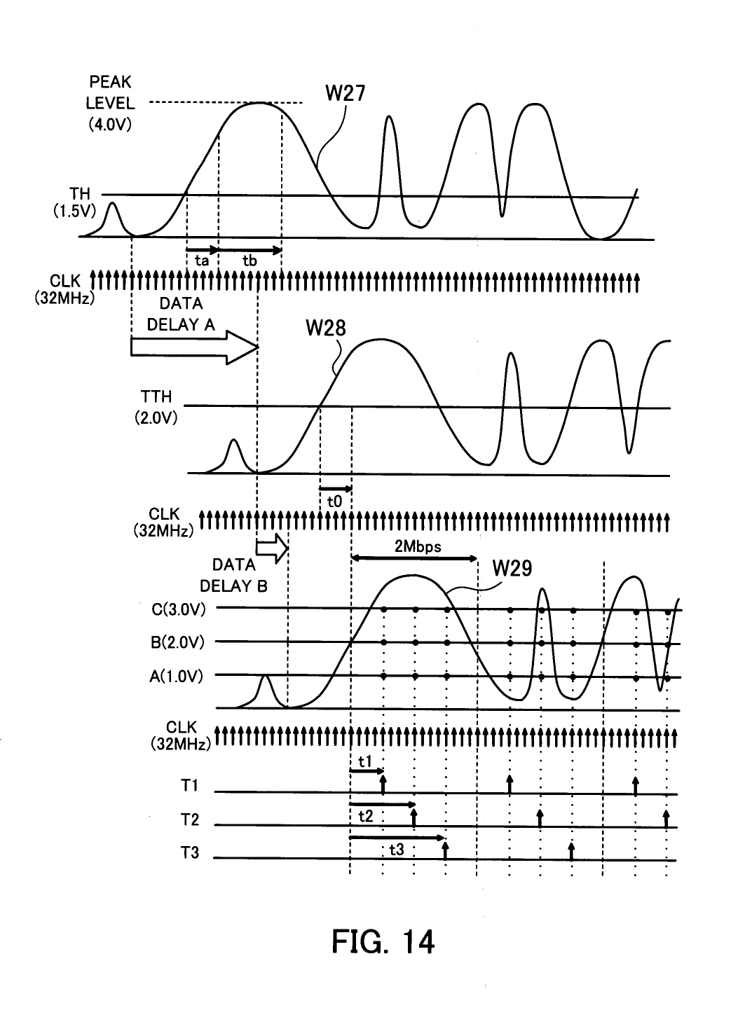

FIG. 14 is a view illustrating the specific values of signals. A signal waveform W27 shown in the figure represents the waveform of received data D output from the data sampling block 11. A signal waveform W28 represents the waveform of the received data D delayed by the data delay block 14. A signal waveform W29 represents the waveform of the received data D delayed by the data delay block 16.

As shown in the figure, let the peak level of the signal waveform W27 be 4.0 V, and let the lowest threshold value TH be 1.5 V, for instance. Suppose that the bit rate of the received data D is 2 Mbps, and suppose that a sampling clock CLK input to the data receiving apparatus 10 has a frequency of 32 MHz, which is the bit rate of the received data D multiplied by 16. It is also assumed that the time ta for noise judgment on the signal waveform W27 by the level judgment block 12 corresponds to four cycles of the sampling clock CLK, and the time tb for monitoring and detecting the peak level corresponds to eight cycles of the sampling clock CLK.

Because the peak level of the signal waveform W27 is 4.0 V, the level judgment block 12 detects the 4.0-V peak level. The threshold value control block 13 calculates a threshold value A of 1.0 V, a threshold value B of 2.0 V, and a threshold value C of 3.0 V by dividing the peak level of 4.0 V evenly, and outputs those values to the data judgment block 17. The threshold value control block 13 outputs the threshold value B of 2.0 V, which is a half of the 4.0-V peak level, to the timing control block 15 as the timing adjustment threshold value TTH.

If the signal waveform W28 keeps exceeding the timing adjustment threshold value TTH for a period longer than the time t0, the timing control block 15 generates judgment timings T1 to T3. The timing control block 15 outputs the signals of the judgment timings T1 to T3 after a lapse of time t1 to t3, respectively, and generates the subsequent timings T1 to T3 automatically at the intervals of the bit cycle tcyc of the received data D. In the shown example, the time t1, the time t2, and the time t3 correspond to four cycles, eight cycles, and twelve cycles of the sampling clock CLK, respectively, and the judgment timings T1 to T3 are generated evenly at intervals of four cycles in the bit cycle of the received data D.

The data receiving apparatus 10 judges whether the received data in each bit section is in ‘1’ or ‘0’ status in accordance with the plurality of threshold values at the plurality of judgment timings, and decides on the judged statuses under majority rule. This makes it possible to judge correctly whether the status is ‘1’ or ‘0’ even if noise is added to the received data, allowing bit errors owing to noise to be reduced.

In addition, bit errors owing to decrease in signal level because of transmission loss or the like can be reduced. Data can be received with reliability in spite of variations in the level.

Because the phase is adjusted when the received data is taken in, a transmission error rate affected by jitter can be improved.

The data receiving apparatus 10 is used as a data receiving block of a repeater unit, as described earlier. Repeater units may be provided at different intervals. For instance, some repeater units may be disposed at intervals of 300 km, and other repeater units may be disposed at intervals of 100 km. The amplitude of received data D may depend on the intervals of the repeater units. The data receiving apparatus 10 judges the status to be ‘1’ or ‘0’ by calculating the threshold values and the like from the amplitude of the received data D, eliminating the need for adapting the data receiving block of each repeater unit for use with the amplitude of the received data D. If repeater units at different distances are connected by a bus, the data receiving blocks of the repeater units need not be adapted for use at the distances.

The level judgment block 12, the threshold value control block 13, and the timing control block 15 perform the processing based on the level of the received data D, but neither bits of the received data D to be used nor the cycle of the processing is limited. For instance, once the threshold values and judgment timings are calculated, the signal statuses may be judged in accordance with the threshold values at the judgment timings until the bit error rate of the received data D become worse to a certain extent. To be more specific, the threshold values and judgment timings may be readjusted if a certain level of deterioration is found while the reception error rate is being monitored. In start-stop synchronous transmission, for instance, errors can be reduced in units of packets by adjusting the threshold values and timings at each first bit. In frame synchronous transmission or the like, readjustment may be made each time a frame becomes out of synchronization. In an apparatus having a redundant structure, readjustment may be made each time the channel is switched. Readjustment may also be made each time the power is turned on.

In the embodiment described above, the received data take either of two values, ‘1’ and ‘0’, depending on the level of the received signal. The present invention, however, can also be applied when the received data take one of k values (k is a natural number greater than or equal to 2), depending on the level of the received signal. It is clear that the same advantages can be obtained by using k or more threshold values. If the received data take three values ‘0’, ‘1’, and ‘2’, a plurality of threshold values (two threshold values, for instance) may be provided to judge whether the level of the received signal is ‘0’ or ‘1’; a plurality of threshold values (two threshold values, for instance) may be provided to judge whether the level of the received signal is ‘1’ or ‘2’; and the judgments are decided on by majority rule. It is clear that this operation increases the accuracy of the value of the data, that is, improves the reception error, rate, in comparison with the operation using a single threshold value.

The data receiving apparatus of the present invention judges the value of the received data in a one-bit section of the received signal in accordance with a plurality of threshold values at a plurality of judgment timings and decides on the judged values by majority rule. Even if noise is added to the received signal, data can be correctly judged, and bit errors owing to noise can be reduced.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A data receiving apparatus, comprising:
threshold value calculation means for calculating n different threshold values (n is a natural number greater than or equal to k) from the amplitude of a received signal for judging which of k values (k is a natural number not smaller than 2) is a received data value;
judgment timing output means for outputting m judgment timings (m is a natural number) in a one-bit section of the received signal;
data judgment means for comparing the received signal with each of the n threshold values at the judgment timing, determining which of the k values is the value of the received signal compared with each of the threshold values, and providing a received data value corresponding to the threshold value at the judgment timing; and
majority-rule judgment means for deciding, by majority rule, on the received data values in the one-bit section obtained as judgments by the data judgment means and outputting the majority of the received data values as data in the one-bit section.

2. The data receiving apparatus according to claim 1, wherein the threshold value calculation means calculates the threshold values by dividing the amplitude of the received signal evenly.

3. The data receiving apparatus according to claim 1, wherein the threshold value calculation means calculates the threshold values when the amplitude of the received signal keeps exceeding a prescribed value for a prescribed period of time.

4. The data receiving apparatus according to claim 1, wherein the judgment timing output means outputs the judgment timings when the amplitude of the received signal keeps exceeding a prescribed value for a prescribed period of time.

5. The data receiving apparatus according to claim 4, wherein the prescribed value is the central value among the threshold values.

6. The data receiving apparatus according to claim 1, wherein the threshold value calculation means and the judgment timing output means output the threshold values and the judgment timings again under a prescribed condition.

7. The data receiving apparatus according to claim 1, wherein the judgment timing output means outputs the judgment timings on the basis of the received data delayed by a period required to calculate the threshold values in the threshold value calculation means.

8. The data receiving apparatus according to claim 1, wherein the data judgment means judges the received signal delayed by a period required by the threshold value calculation means to calculate the threshold values and by the judgment timing output means to output the judgment timings.

9. A received-data judgment method for a data receiving apparatus for judging which of k values (k is a natural number not smaller than 2) is a received data value of a received signal, comprising steps of:
calculating n different threshold values (n is a natural number greater than or equal to k) from the amplitude of the received signal in threshold value calculation means, for making the judgment;
outputting m judgment timings (m is a natural number) in a one-bit section of the received signal, in judgment timing output means;
comparing the received signal with each of the threshold values at the judgment timing and determining which of the k values is the value of the received signal compared with each of the threshold values, in data judgment means; and
deciding, by majority rule, on the received data values obtained as judgments by the data judgment means in the one-bit section and outputting the majority of the received data values as data in the one-bit section, in majority-rule judgment means.
